(19) United States
(12) Patent Application Publication
(10) Pub. No.: US 2006/0247946 A1
(43) Pub. Date: Nov. 2, 2006

(54) System and method for soliciting reviews of local businesses

(76) Inventor: Raz Gordon, Hadera (IL)

Correspondence Address: Collage Analytics LLC, 1652 48th Street, Brooklyn, NY, 11204, US

(21) Appl. No.: 11/379,056

(22) Filed: Apr. 18, 2006

Related U.S. Application Data
(60) Provisional application No. 60/594,568, filed on Apr. 19, 2005.

(51) Int. Cl. G06Q 99/00

(52) U.S. Cl. 705/1

(57) ABSTRACT

A method and system for actively encouraging clients of businesses such as retail stores and service providers, to submit reviews of such businesses to an Internet yellow pages website. Using the methods and system, a business will employ any of several methods to provide encouragement and/or incentive at the physical point of sale for the customer to acces an Internet yellow pages site to submit a review of the business.

### CROSS REFERENCE TO RELATED APPLICATION

Benefit is claimed under 35 USC §119(e)(1), to the filing date of U.S. provisional patent application No. 60/594,568, entitled “System and Method for Soliciting Reviews of Local Businesses”, filed on Apr. 19, 2005. The aforementioned patent application is hereby incorporated herein by reference in its entirety.

### BACKGROUND OF THE INVENTION

The common telephone yellow pages concept has been applied to the Internet by several prominent websites such as Yahoo! Yellow Pages, SMARTpages.com, YP.com, Citysearch.com., etc. The capability and versatility of the Internet has provided a large number of services not available in a standard printed yellow pages book. For example, the typical yellow pages web sites allow the user to quickly search for businesses, products and services in his or her local area based on various criteria. Most provide maps and driving directions to businesses being searched for. For additional convenience, searches based on geographical areas can be performed, such as a radius around a specified location. Searches can be performed for a given street or in a given business category. In addition to location and basic information about any business, the searcher can select a link to a business' website (if one exists) for more detailed information about the business, allowing a better basis for comparison between competing businesses. The combination of these features gives the searcher vastly expanded ease and capability over printed yellow pages in finding and learning about local businesses and services.

One area of promise for Internet yellow pages that has not been utilized with any effectiveness is the collection, storage and dissemination of customer reviews for local businesses and service providers. Most buyers of products or services will welcome any useful information provided by previous users or purchasers, and several websites provide this service on a more general basis. For example, consumerREVIEW.com has created a network of sites such as computerREVIEW.com, carREVIEW.com, etc. to provide the prospective purchaser information and experiences from current owners of various products. Another popular site of this type is Epinions.com, providing an extensive database of reviews on a wide range of products. In addition to the professional reviews that one can find on the Internet, feedback of this type from an “average” customer has particular value to most would-be buyers, since a larger number of users are involved and their comments are often more likely to reflect the experience and perceived value of the user, rather than a professional reviewer who was provided the product at no cost and whose experience with the product may be of a limited duration. These websites display user reviews alongside the general information and professional reviews available for a given product. Visitors to these websites are invited to offer their own review of products they have purchased, and are more likely to do so if the existing reviews are comprehensive and useful. Given the wide use and interactive nature of the Internet, it would seem natural to extend the reviews concept to local businesses and services through the yellow pages concept. However, several factors have resulted in this advantage not being fully implemented.

Firstly, many consumers are not aware of the existence of Internet yellow pages sites and even those who use them occasionally do not know that they may be able to write feedback useful to future or prospective customers. This is partly because most Internet yellow pages sites do not actively encourage submission of reviews. Few sites display a solicitation for reviews with any prominence, and few reviews, if any, can be found on most of these sites. Secondly and more importantly, there is no effective mechanism to connect the purchase and use of a product or service to the creation of a review. Consumers currently utilize the Internet Yellow Pages while they are still in the process of searching for a business or service provider—not a good time to solicit reviews. Also, after the consumer has completed a transaction or service engagement, there is no reminder or incentive for the consumer to return to the Internet yellow pages website to submit a review. Yet another factor is the lack of any mechanism to bring the reviews to the attention of the business owner. Generally speaking, a customer will only bother to report a good or bad shopping or product experience if he or she believes it will be reported back to the business, either as a means to encourage good service or to effect change in existing policies or practices. Without that link, there is little reason for a customer to go to the effort of creating a positive or negative review, since it may be viewed as merely a futile exercise.

### SUMMARY OF THE INVENTION

A method and system consistent with the principle of the present invention provides methods for actively soliciting clients of businesses such as retail stores and service providers, to submit reviews of these businesses to an Internet yellow pages website. Using the methods consistent with the principles of the present invention, a business will employ any of several methods to provide encouragement and/or incentive at the physical point of sale for the customer to go to an Internet yellow pages site to submit a review of the business.

### DETAILED DESCRIPTION OF THE INVENTION

The following description of a preferred embodiment of the present invention is presented to enable one skilled in the art to make and use the invention.

Internet Yellow Pages Review Website Deployment

A typical Yellow Pages website, upon which the reviews function described herein can be deployed, should preferably include the following general functions and capabilities:
1. listings of businesses in each geographical area;
2. search capability for a business by business category, business name, street address, street name, zip code or radius around a given address
3. maps and/or driving directions for any business or location; and
4. basic information about businesses and/or links to business websites;

The website system and interface is deployed with programming languages (HTML, Javascript, PHP, ASP, etc.) and database applications (Mysql, SQL, Access, etc.) well known in the art. The website is hosted on a server using server applications such as Apache and Windows well known in the art. The website is accessible by consumers via remote computer terminals.

The website preferably distinguishes itself on its homepage, as specialized Yelow Pages website, with special features for soliciting and for disseminating consumer reviews of local businesses and service providers. The search results list returned by the Yellow Pages website may include an overall rating for each listing and the number of reviews received for each listing. A reviews button may be provided which, when selected, will allow the user to read the available reviews.

Consumer Reviews

The website enables a user such as a consumer, to register with the system through the user's remote computer terminal connected to the Internet. Such registration is required prior to accepting the user's review. The registration process requires the user to submit personal information such as name, address, telephone number, email address and the user's choice of user ID and password. Registration confirmation may be automatically sent back to the user by email. The user may then be required to click on a link in the email in order to effectuate the registration.

The website enables a registered user to submit a review, preferably only after logging into the system using the user ID and password previously selected. A user wishing to submit a review for a particular business would first conduct a search for the business, by entering query information such as the business name or the telephone number of the business. Once the business is located and displayed to the user, the user may submit a review for the business by clicking on a review button alongside the business. The review button may directly link the user to a web page for submitting the review, or may first direct the user to a web page that contains all the reviews previously submitted for this particular business, and a link in this web page would allow the user to post a new review. The reviews are submitted using an online form with fields, which the user can complete. Some of the fields may be mandatory, while others may only be optional. These fields may include such items as:
Title of the review (provides a quick reference to the nature of the review);
Business description (describes the business in the eyes of the reviewer);
Date (day or period of time relating to the product purchase or service rendered);
Comments (positive or negative comments about the business or service);
Pros and Cons (provides a list of pros and cons for the business);
Overall Rating (overall rating on a five or ten point scale); and
Itemized Rating (each business type may have list of items, which may be individually rated. These may include: wait time; pricing; demeanor; variety, etc.

The site may also contain guidelines for submitting reviews to discourage inflammatory or inappropriate review comments. The review information entered in the fields is stored in a central database along with all the other site information. Subsequent site visitors may select a reviews button for a given business to read the previously stored reviews. A feature may also be provided that will allow site visitors to post comments on the reviews that they are reading. Such commenting on reviews may be in the ‘message board’ style widely in use today on the web. Another feature may also be provided which allows the users reading a review to indicate whether the review was useful. The site may then display the total number of people who have read the review and the relative percentages or numbers of those users who did or did not find the review useful.

Soliciting Reviews

For the purpose of raising the awareness of the reviews website and encouraging customers to visit the website and submit reviews, the following novel method is employed.

The website owner or operator may design and print a variety of posters, placards, cards (e.g. post cards or business cards) or other printed matter (hereinafter referred to collectively as “solicitation material”) directing consumers to the website for the purpose of submitting reviews of local businesses. This solicitation material may be provided to each business by postal mail or other means, with an accompanying letter explaining the purpose and use of the solicitation material and describing the value to the business of encouraging its customers to submit reviews.

The business owner or service provider may display the solicitation material in a conspicuous place in the business such as the front desk, checkout counter or waiting room. The business owner may also furnish their customers with RFID tags. Some of the solicitation material like post cards may be available for voluntary customer pickup. The business may also furnish its visiting customers with RFID tags. The solicitation material message may be a subtle or explicit invitation for the consumer to visit the website for the purpose of submitting a review of the business. The website owner or operator may also provide personalized solicitation material to each business with a message such as “Submit a review of Dr. Johnson at www.bizreviews.com.” Such personalization has two advantages. It makes the use and appearance of the solicitation material more appealing to the business and also provides an added psychological incentive to the consumer to submit a review. The solicitation material might also be more actively distributed, such as placing a flyer along with the purchase in each customer's sack. Solicitation for reviews may also be conveyed to customers of the business on store receipts, monthly account statements or any other regular or special written correspondence.

The website may also include a catalog of various types of solicitation material for the business to choose from, in accordance with what would fit that business best. If the business chose to order solicitation materials in addition to the packet it initially received, a nominal fee could be charged. The business could also print its own solicitation material when the value of receiving reviews had been established.

An additional or alternative means for soliciting review from consumers is for the operator of the Yellow Pages website to contact the consumer subsequent to the visit to the merchant or psot-transaction. The consumer may be contacted by email, phone, SMS, etc. Customer contact information may be acquired using various sources: from the merchants, from credit card company databases, registration with the feedback service, other online services, white pages, etc.

Credit card companies are particularly a very good source for consumer contact information. Credit card companies generally know many things about transaction between business and consumers, such as the business identification, the customer identification, the amount, the date, etc. Some or all of this information may be used by credit card companies to contact the customer in order to encourage him/her to give feedback. The contact information of consumers may also be provided by the credit card companies directly to the Yellow Pages reviews system, which will use it to contact the customer.

Email can also be used as a low cost and effective means of soliciting customers to submit a review of the business, based on their most recent transaction. Many businesses retain an email list or lists of all their customers who provide an email address and agree to receive emailed information about new products, store specials, etc. Solicitation for email addresses may be done on the business' website, at the point of sale and through any regular company mailings. Various services such as autoresponders (GetResponse.com or Aweber.com) or email list managers (Topica.com or Lyris.com) perform the functions of automatically adding submitted names to the list and automatically emailing all list members any message prepared by the business for that purpose. The reviews website may also provide the businesses with a service of automatically sending an email message to their client email list. The website may allow a business to select from a variety of different email message templates for sending to its clients. The business may then optionally modify the email message as it chooses. The business would then enter its list of names and email addresses for automatic forwarding of the email message to all the recipients entered. The business may periodically send out such emails for all the customers served in the most recent time period.

A business could also choose to encourage review submissions by including in its solicitation an offer for an incentive such as discount on future purchases or entry in a drawing, according to policies that could be established by the website owner or operator.

Appended to this specification are one or more claims, which may include both independent claims and dependent claims. Each dependent claim makes reference to an independent claim, and should be construed to incorporate by reference all the limitations of the claim to which it refers. Further, each dependent claim of the present application should be construed and attributed meaning as having at least one additional limitation or element not present in the claim to which it refers. In other words, the claim to which each dependent claim refers is to be construed and attributed meaning as being broader than such dependent claim.

The invention has been described herein in the context of a preferred embodiment. Various modifications to the preferred embodiment described herein will be readily apparent to those skilled in the art, and general principles defined herein may be applied to other embodiments and applications without departing from the spirit and scope of the invention. The present invention is not intended to be limited to the embodiment shown, but is to be accorded the widest scope consistent with the appended claims.

1. In a computer system coupled to a network being accessible to a plurality of consumers via remote terminals, a method for receiving a consumer review about a business, the method comprising:
providing at the computer system an input interface for accepting reviews about the business;
conspicuously placing by the business soliciting material at a physical location associated with the business, wherein the physical location is visited by one or more consumers, and wherein the soliciting material directs the one or more consumers to a network address of the computer system and indicates a capability of posting reviews about the business to the computer system; and
receiving at the computer system the consumer review about the business from one of the one or more consumers.

2. The method of claim 1, wherein an owner of the computer system provides the soliciting material to the business.

3. The method of claim 1, wherein the soliciting material is one or more members of printed matter.

4. The method of claim 3, wherein each member of printed matter is a business card.

5. The method of claim 3, wherein the one of the one or more consumers is provided by the business one of the one or more members of printed matter.

6. The method of claim 1, wherein the soliciting material is a placard.

7. In a computer system coupled to a network being accessible to a plurality of consumers via remote terminals, a method for receiving a consumer review about a business, the method comprising:
providing at the computer system an input interface for accepting reviews about the business;
encouraging by an owner of the computer system the business to further encourage consumers that are clients of the business to submit reviews of the business to the computer system;
encouraging by the business one of the consumers that are clients of the business, to submit a review of the business to the computer system; and
receiving at the computer system the consumer review about the business from the one of the consumers.

8. The method of claim 7, wherein the owner encourages the business by sending soliciting material to the business.
